(19) United States
(12) Patent Application Publication
(10) Pub. No.: US 2008/0092960 A1
(43) Pub. Date: Apr. 24, 2008

(54) VALVE SYSTEM WITH POSITION SENSOR

(76) Inventors: Peter Manecke, Frammersbach (DE); Harald Hahn, Neuhuetten (DE); Peter Graf, Lohr am Main (DE); Rainer Imhof, Frammersbach (DE); Torsten Witte, Lohr am Main (DE)

Correspondence Address: Striker, Striker & Stenby, 103 East Neck Road, Huntington, NY, 11743, US

(21) Appl. No.: 11/875,070

(22) Filed: Oct. 19, 2007

(30) Foreign Application Priority Data
Oct. 21, 2006 (DE) 10 2006 049 724.4

(51) Int. Cl. F16K 37/00

(52) U.S. Cl. 137/554; 251/65

(57) ABSTRACT

A valve system has a valve housing, in which at least one valve element is displaceably guided. At least one magnetic field sensor is provided to detect the position of the valve element, which is acted upon by the magnetic field of at least one permanent magnet located on the movable valve element. The permanent magnet is guided relative to the magnetic field sensor such that it is non-rotatable but axially displaceable in the valve housing.

### CROSS-REFERENCE TO A RELATED APPLICATION

The invention described and claimed hereinbelow is also described in German Patent Application DE 10 2006 049 724.4 filed on Oct. 21, 2006. This German Patent Application, whose subject matter is incorporated here by reference, provides the basis for a claim of priority of invention under 35 U.S.C. 119(a)-(d).

### BACKGROUND OF THE INVENTION

The present invention generally relates to valve systems,

A valve system with position sensor is made known, e.g., in EP 1 184 611 B1. This conventional valve system has a valve housing with a slide bore in which a valve spool is guided, the valve spool being controllable using pilot valves such that a flow of hydraulic fluid from a pump connection or a tank connection may be directed to working connections. With this means of attaining the object of the present invention, a magnetic field sensor is provided to detect the position of the valve spool, the valve spool being acted upon by the magnetic field of an annular permanent magnet located on the valve spool.

The magnetic field sensor is accommodated in a projection of a non-magnetic housing part that extends into a recess of the valve housing. The magnetic field sensor is therefore positioned in the region of the lines of magnetic field strength of the permanent magnet. The magnetic field sensor detects the magnitude of the magnetic field produced by the permanent magnet and acting on the corresponding point in the region of the magnetic field sensor, thereby making it possible to detect the position of the valve spool of the directional control valve by detecting the position of the magnet using the magnetic field sensor. In particular, the magnetic field sensor serves to detect the position of a pressure valve or a directional control valve, in order to monitor a valve position, e.g., an end position or a central position, or it serves as a displacement pick-up of a proportional directional control valve.

The disadvantage of valve systems of this type is that the permanent magnet may rotate relative to the magnetic field sensor. As a result, the magnetic field of the permanent magnet that acts on the magnetic field sensor changes due to the inhomogeneous orientations of the magnetic material, and due to tolerances of form and position of the permanent magnets and their receptacles, thereby resulting in an inhomogeneous magnetic field. The measured results often do not meet the high requirements placed on the position detection of the valve spool.

### SUMMARY OF THE INVENTION

Accordingly, it is an object of the present invention to provide a valve system with position detection of a valve element which is an improvement of the existing valve systems.

In keeping with these objects and with other which will become apparent hereinafter, one feature of the present invention resides, briefly stated, in a valve system, a valve housing; at least one valve element which is displaceable guided in said valve element; at least one permanent magnet located on said valve housing; a magnetic field sensor configured for detecting a position of said valve element, which is acted upon by a magnetic field by said at least one permanent magnet, said permanent magnet being guided relative to said magnetic field sensor such that it is non-rotatable but axially displaceable in said valve housing.

The inventive valve system includes a valve housing, in which at least one valve element is displaceably guided. At least one magnetic field sensor is provided to detect the position of the valve element, which is acted upon by the magnetic field of at least one permanent magnet located on the movable valve element. According to the present invention, the permanent magnet is guided relative to the magnetic field sensor such that it is non-rotatable but axially displaceable in the valve housing. With the inventive means of attaining the object of the present invention—in contrast to the related art described in EP 1 184 611 B1—an essentially homogeneous magnetic field of the permanent magnet is attained during the axial displacement (reciprocating motion) of the valve element.

The results measured by the magnetic field sensor therefore also meet the high requirements placed on the position detection of the valve spool. The at least one permanent magnet is located in or on the longitudinally-movable valve element such that the size and direction of the magnetic field of the permanent magnets bring about a corresponding output voltage of the magnetic field sensor as a function of the displacement of the magnet. The geometric dimensions and the field strength of the permanent magnets—which depends on the material used—and the distance between the permanent magnets and the magnetic field sensor determine the characteristics of the magnet displacement/magnetic field sensor output signal.

According to a particularly preferred exemplary embodiment, the valve element is guided via at least one rotation lock such that is non-rotatable but axially displaceable in the valve housing. It has proven particularly advantageous when the rotation lock includes at least one guide element that is guided in a sliding link.

In the inventive exemplary embodiment, the guide element is designed as a cylindrical pin inserted in the valve element or a guide sleeve assigned thereto, and which is engaged—in sections—with a nearly groove-shaped recess—which functions as a sliding link—of the guide sleeve or valve element.

In an alternative embodiment of the present invention, the rotation lock is produced via at least one flat section of the valve element that interacts with at least one flat section of the guide sleeve, which serves as a rotation lock. It has proven advantageous to design the flat section as an indentation that is formed tangentially in the guide sleeve. The indentation may be formed in the guide sleeve with a contour that is close to the final contour using simple production means, e.g., by using a stamping tool with a clamp. The valve element is designed, e.g., as a nearly hexagonal tube that is placed in the indentation of the guide sleeve via at least one lateral surface, thereby enabling it to be guided in a non-rotatable manner.

The rotation lock is preferably located in the region of the magnetic field sensor, so that the measuring accuracy essentially remains unaffected if torsion occurs in the valve element.

According to the present invention, it is particularly preferred when at least one magnetizable material is assigned to the magnetic field sensor to concentrate the flux of the magnetic field emitted by the permanent magnet. The conductance of flux in the material modifies the direction of the magnetic field lines, so that the signal/displacement characteristic is nearly linear across a wide range of displacement. As a result, a large measuring range is attained with greatly improved measuring accuracy of the position detection.

In a preferred embodiment of the present invention, the magnetic field sensor is located in a recess of the valve housing and/or guide sleeve, which extends essentially transversely to a longitudinal axis of the valve element.

It has proven advantageous in terms of production when the valve element is designed—at least in sections—as a hollow cylinder and when the permanent magnet includes at least one cylindrical or round magnet that is located in the valve element. Plastic-bound SmCo rare earth or neodymium iron boron materials, for example, are used for the permanent magnets.

According to a particularly preferred exemplary embodiment, at least one Hall effect sensor is used as the magnetic field sensor. Hall sensors (Hall probes) of this type use the Hall effect to measure changes in magnetic fields. When current flows through the Hall sensor and it is placed in the magnetic field of the proportional magnet extending perpendicularly thereto, it delivers an output voltage that is proportional to the magnetic field strength. The position of the valve element may be determined based on the change in field strength measured, and a useful sensor signal is generated. Programmable CMOS Hall sensors with a digital signal processor are used, for example.

In one exemplary embodiment, the guide sleeve is composed of a magnetically non-conductive material, in particular austenitic steel, aluminium, or plastic, thereby effectively preventing magnetization by the permanent magnets and, therefore, an undesired influence by the magnetic field sensor.

To shield the magnetic field sensor from external influences, such as extraneous magnetic fields or the like, it is preferably shielded by at least one shield composed of a magnetically conductive material, in particular steel or coated plastic. The shield may be, e.g., at least one part of the valve housing, a hollow cylinder that encloses the magnetic field sensor at least in sections, a shield plate, a shield foil, or an applied coating. The shield also serves to concentrate the flux and the field lines.

In a specific exemplary embodiment, the valve system includes a valve spool, that may be acted upon via the valve element with the force of an electricomagnet (controlling magnet). In this variant, it is preferred when the shield is connected with the electromagnet in a magnetically conductive manner, so that the stray field of the electromagnet is short-circuited and does not influence the sensor output signal.

During operation of the valve system, to prevent the permanent magnet from attracting magnetizable particles, e.g., chips, worn-off material, or the like, from the flow of hydraulic fluid and allowing them to deposit on the permanent magnet, the permanent magnet is preferably located outside of the flow of hydraulic fluid. As a result, the permanent magnet is effectively prevented from becoming contaminated with magnetizable particles, and the magnetic fields are therefore effectively prevented from being influenced. According to a particularly simple means of attaining the object of the present invention, the permanent magnet is located in at least one receiving space such that it is spacially separated from the flow of hydraulic fluid. For example, the magnetic field sensor is located in the region between the guide sleeve and the shield.

In particular, the magnetic field sensor serves as a position sensor to monitor a valve position, e.g., of a pressure valve or a directional control valve, and/or as a displacement pick-up in a proportional directional control valve. To this end, the magnetic field sensor is preferably connected with a microprocessor for detecting and evaluating the sensor signals.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a longitudinal sectional view through an inventive valve system according to a first exemplary embodiment;

FIG. 2 shows a detailed view of the valve system in FIG. 1;

FIG. 3 shows a longitudinal sectional view through a portion of an inventive valve system according to a second exemplary embodiment;

FIG. 4 shows a side view of the valve system in FIG. 3;

FIG. 5 shows a longitudinal sectional view through an inventive valve system according to a further exemplary embodiment, and

FIG. 6 shows a side view of the valve system in FIG. 5.

### DESCRIPTION OF THE PREFERRED EMBODIMENTS

The present invention will be explained below with reference to 2/2 way proportional directional control valves with a cartridge design, as are used, e.g., as screw-in valves in mobile hydraulics. As mentioned initially, the inventive valve system is not limited to these types of valves.

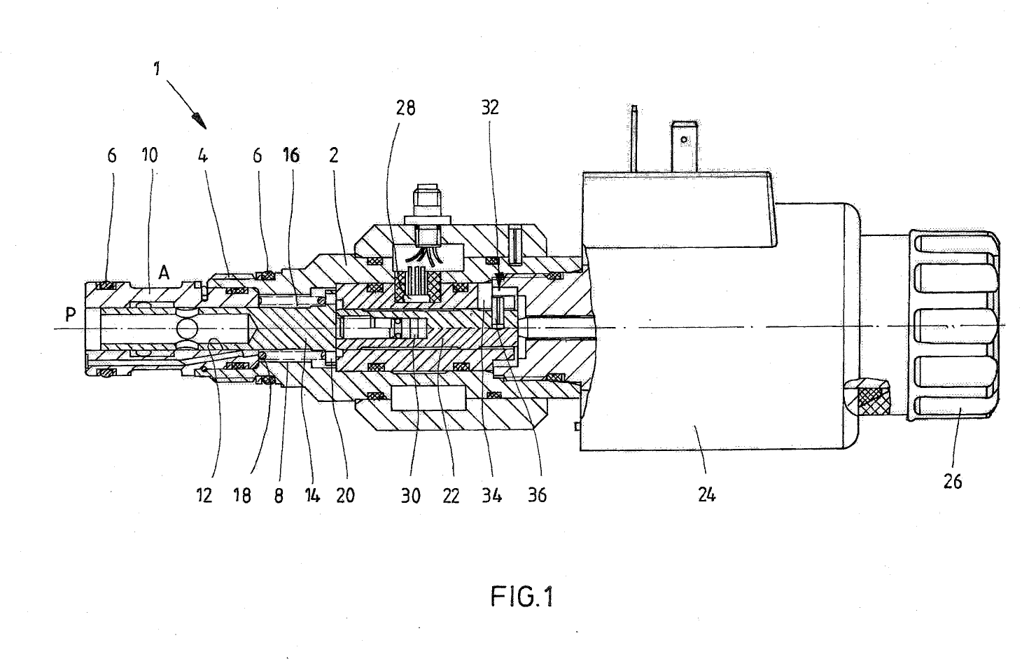

FIG. 1 shows a longitudinal cross section through an inventive valve system 1 designed as a continually adjustable 2/2 way proportional directional control valve with a cartridge-shaped valve housing 2, which can be screwed into a control block housing (not shown) via a thread 4. To this end, valve housing 2 has regions with stepped diameters, which interact with a corresponding stepped bore in the control block housing. A pump connection P and a working connection A of valve housing 2 are sealed off from each other via sealing rings 6.

Valve housing 2 has a stepped receiving bore 8 in which a housing insert 10 is inserted, and which includes a valve bore 12, in which a valve spool 14 is guided in an axially movable manner, via which the cross section of hydraulic fluid between pump connection P and working connection A is controllable. Valve spool 14 is loaded in the closing direction by a compression spring 18 located in a spring chamber 16. Compression spring 18 is supported on housing insert 10 of valve housing 2 and engages with valve spool 14 via a radial collar 20. Valve spool 14 may be acted upon in the direction of opening and out of the closed position shown via a valve element 22 bearing against the end face of valve spool 14 by the force of an electromagnet 24 and against the force of compression spring 18. Valve spool 14 may also be actuated via an auxiliary actuating device 26 without magnetic excitation.

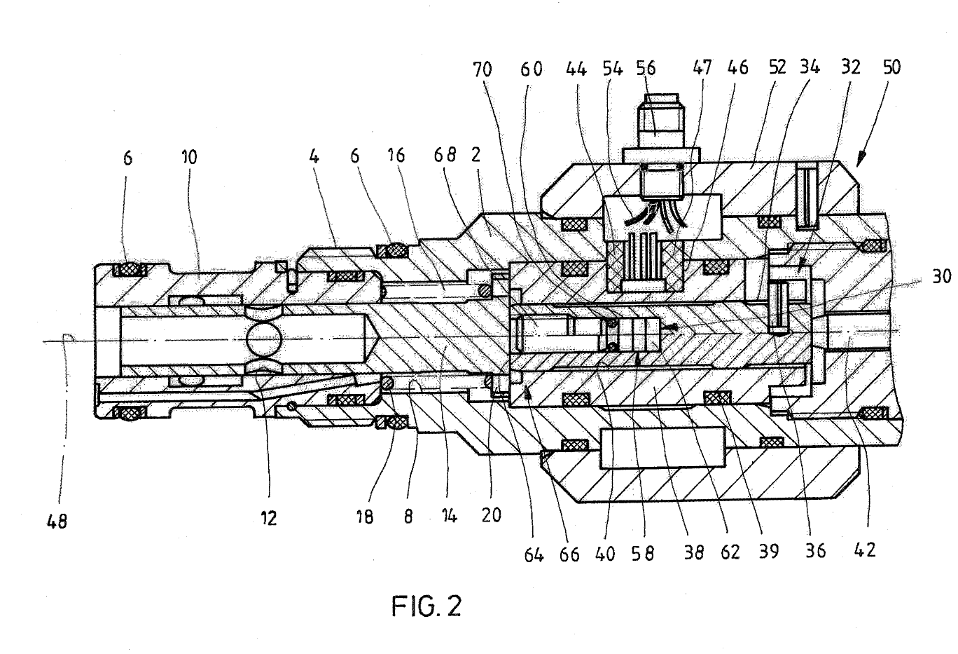

Valve system 1 has a magnetic field sensor 28 for detecting the position of valve element 22 and, therefore, valve spool 14, which is acted upon by the magnetic field of a permanent magnet 30 located on movable valve element 22. According to the present invention, permanent magnet 30 is guided via valve element 22 relative to magnetic field sensor 28 in a manner such that it is non-rotatable but axially displaceable in valve housing 2, therefore resulting in an essentially homogeneous magnetic field of permanent magnet 30 when valve element 22 undergoes axial displacement. Magnetic field sensor 28 serves as a limit switch to monitor a valve position. In a not-shown exemplary embodiment, magnetic field sensor 28 is used as a displacement pick-up of valve spool 14. Valve element 22 is guided via a rotation lock 32 in a manner such that it is non-rotatable but axially displaceable in valve housing 2. Rotation lock 32 includes a guide element 36, which is guided in a sliding link 34. Further details of valve system 1 are explained with reference to the detailed depiction in FIG. 2.

According to FIG. 2, guide element 36 is designed as a cylindrical pin inserted radially in valve element 22, and which is engaged—in sections—with a groove of a guide sleeve 38 inserted in valve housing 2, the groove serving as sliding link 34. Guide sleeve 38 is sealed against the inner wall of valve housing 2 via sealing rings 39, and includes a through-bore 40, in which valve element 22 is guided. Since electromagnet 24 bears against the end face of valve element 22 only in a non-positive manner via an armature 42, relatively small amounts of torque are transferred to valve element 22 as compared with a form-fit connection. As a result, the load on rotation lock 32 and, therefore, the frictional losses, are low.

A Hall sensor is used as magnetic field sensor 28. It is fixed in position in a blind hole 46 of guide sleeve 38 and in a through-hole 47 of housing 2 via a plastic insert 44 composed of polyoxymethylene (POM). Blind hole 46 and through-bore 47 extend nearly transversely to a longitudinal axis 48 of valve element 22. To shield magnetic field sensor 28 from external influences, such as extraneous magnetic fields or the like, it is preferably shielded by a shield 50 composed of a magnetically conductive material, in particular steel or coated plastic. In the exemplary embodiment shown, a piece 52 of valve housing 2 that covers magnetic field sensor 28 from the inside toward the outside is used as shield 50.

Shield 50 is connected with electromagnet 24 in a magnetically conductive manner, so that its stray field is short-circuited and does not influence the sensor output signal. Electrical lines 54 lead away from magnetic field sensor 28 to a plug-and-socket connection 56 fixed in position in housing piece 52. During operation of valve system 1, to prevent permanent magnet 30 from attracting magnetizable particles, e.g., chips, worn-off material, or the like, from the flow of hydraulic fluid and allowing them to deposit on permanent magnet 30, the permanent magnet is preferably located outside of the flow of hydraulic fluid. According to a particularly simple means of attaining the object of the present invention, permanent magnet 30 is located in a receiving space 58 such that it is spacially separated from the flow of hydraulic fluid.

Receiving space 58 is designed as blind hole 60 for accommodating three nearly cylindrical permanent magnet disks 62 such that they are adjacent to one another, and it is inserted in an end face 64 of an end section 66 of valve element 22. As a result, permanent magnet 30 is effectively prevented from becoming contaminated with magnetizable particles, and the magnetic field is therefore effectively prevented from being influenced. Permanent magnet disks 62 are fixed in position in valve element 22 via a threaded insert 68 that is screwed into blind hole 60, and they are sealed off with a sealing ring 70.

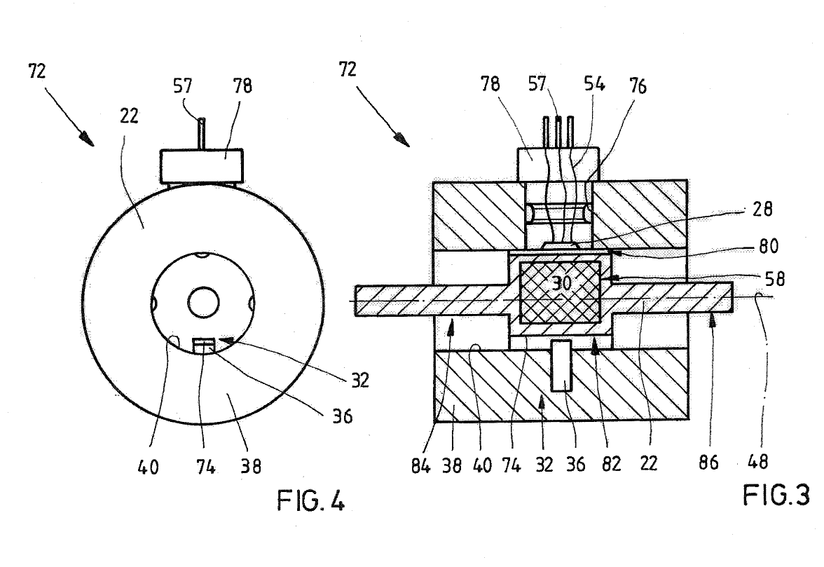

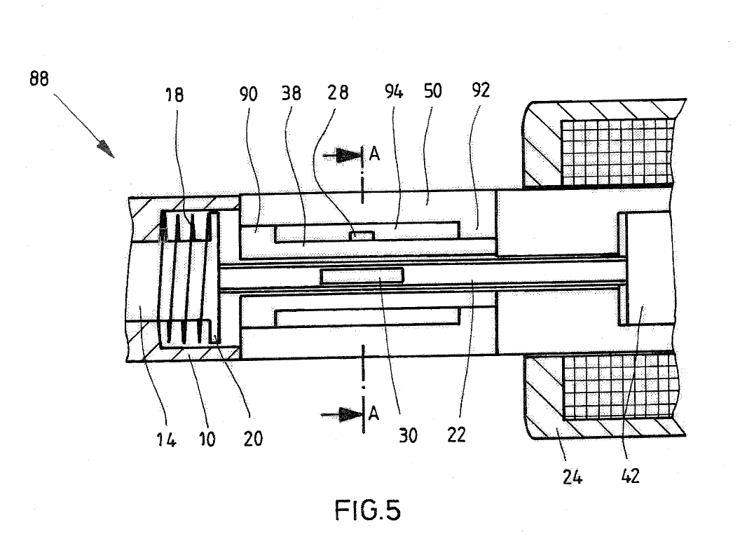

According to FIG. 3, which shows a longitudinal sectional view through a portion of an inventive valve system 72 in the region of magnetic field sensor 28 according to a second exemplary embodiment, cylindrical pin 36 is inserted in guide sleeve 38—which is composed of a magnetizable material, e.g., steel, in this variant—and engages in a guide groove 74 of valve element 22, which extends parallel to longitudinal axis 48 of valve system 72. As shown in FIG. 4, which shows a side view of valve system 72 in FIG. 3, guide groove 74 has an essentially rectangular cross section. Rotation lock 32 is located located on the side diametrically opposed to magnetic field sensor 28, so that the measuring accuracy remains essentially unaffected if torsion occurs in valve element 22.

The receptacle for magnetic field sensor 28 is inserted as radial bore 76 in guide sleeve 38. Using plastic insert 78, magnetic field sensor 28 is located as close to inner port 80 of radial bore 76 as possible. The conductance of flux in magnetically conductive guide sleeve 38 results in a flux concentration of the magnetic field emitted from permanent magnet 30. A large linear measuring range and greatly improved accuracy in the position detection are therefore attained. Magnetic field sensor 28 is contactable via electrical lines 54 and contact pins 57. In this exemplary embodiment, permanent magnet 30 is located in a receiving space 58 of valve element 22 formed in the region of a guide section 82 of valve element 22. On the ends, guide section 82 transitions into a radially offset actuating section 84, 86.

FIG. 5 shows a longitudinal sectional view through an inventive valve system 88 according to a further exemplary embodiment, in which valve element 22 is designed as a hollow cylinder and accommodates a rod-shaped permanent magnet 30. Hollow cylinder 22 is brought to bear—in a sealing manner—against armature 42 of electromagnet 24 and valve spool 14, so that, during operation of valve system 88, permanent magnet 30 may not attract any magnetizable particles from the flow of hydraulic fluid. As a result, permanent magnet 30 is effectively prevented from becoming contaminated with magnetizable particles, and the magnetic fields are therefore effectively prevented from being influenced.

In this exemplary embodiment, guide sleeve 38 is designed as a pressure tube, and it is provided with a radial collar 90 on the outside. To shield against external influences, such as extraneous magnetic fields or the like, magnetic field sensor 28 is shielded by a tubular shield 50 composed of a magnetically conductive material, e.g., steel or coated plastic. Shield 50 is brought to bear against guide sleeve 38 via a radial collar 92 on the inside. Inner surface of shield 50 bears against radial collar 90 of guide sleeve 38 such that a sensor compartment 94 for accommodating magnetic field sensor 28 is formed. Shield 50 is connected with electromagnet 24 in a magnetically conductive manner, so that the stray field of electromagnet 24 is short-circuited and does not influence the sensor output signal.

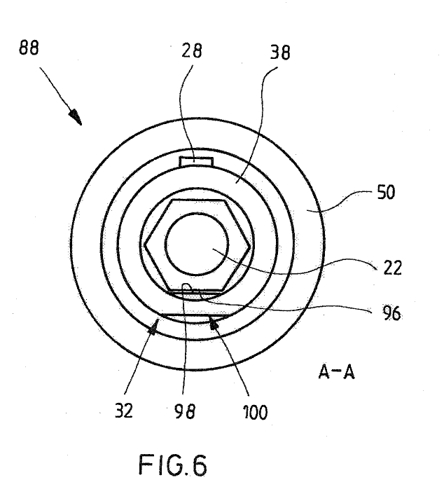

According to FIG. 6, which shows a sectional view along line A-A in FIG. 5, the rotation lock is realized in this exemplary embodiment via a flat section 96 of valve element 22, which interacts with a flat section 98 of guide sleeve 38. It has proven advantageous to design flat section 98 as an indentation 100 that is formed tangentially in guide sleeve 38. The indentation may be formed in the guide sleeve with a contour that is close to the final contour, e.g., by using a stamping tool with a clamp. Valve element 22 is designed as a nearly hexagonal tube that is placed in indentation 100 of guide sleeve 38 via flat section 96, thereby enabling it to be guided in a non-rotatable manner.

Inventive valve system 1, 72, 88 is not limited to the exemplary embodiments described with permanent magnet 30 located in valve element 22. Permanent magnet 30 may also be located outside of valve element 22. Permanent magnet 30 may also be mounted on valve spool 14. Permanent magnet 30 and magnetic field sensor 28 may be located relative to each other such that magnetic field sensor 28 detects the magnetic field of permanent magnet 30 when valve element 22 is located in an end position, or such that magnetic field sensor 28 detects the magnetic field for the entire duration of movement of valve element 22, in order to continually ascertain the change in position of valve element 22.

Disclosed is a valve system 1, 72, 88 with a valve housing 2, in which at least one valve element 22 is displaceably guided. At least one magnetic field sensor 28 is provided to detect the position of valve element 22, which is acted upon by the magnetic field of at least one permanent magnet 30 located on movable valve element 22. According to the present invention, permanent magnet 30 is guided relative to magnetic field sensor 28 such that it is non-rotatable but axially displaceable in valve housing 2.

It will be understood that each of the elements described above, or two or more together, may also find a useful application in other types of constructions differing from the type described above.

While the invention has been illustrated and described as embodied in a valve system with position sensor, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A valve system, a valve housing; at least one valve element which is displaceably guided in said valve housing; at least one permanent magnet located on said valve element; a magnetic field sensor configured for detecting a position of said valve element, which is acted upon by a magnetic field of said at least one permanent magnet, said permanent magnet being guided relative to said magnetic field sensor such that it is non-rotatable but axially displaceable in said valve housing.

2. A valve system as defined in claim 1; and further comprising at least one rotation lock, said valve element being guided via said at least one rotation lock such that it is non-rotatable but axially displaceable in said valve housing.

3. A valve as defined in claim 2; and further comprising a sliding link, said rotation lock including at least one guide element that is guided in said sliding link.

4. A valve system as defined in claim 3, wherein said guide element is configured as a cylindrical pin which is inserted in a member selected from the group consisting of said valve element and a guide sleeve assigned thereto, which is engaged—in sections—with a groove of said member that functions as a sliding link.

5. A valve system as defined in claim 4, wherein said valve element includes at least one flat section which interacts with at least one flat section of said guide sleeve as a rotation lock.

6. A valve system as defined in claim 5, wherein said at least one flat section of said guide sleeve is configured as an indentation formed tangentially in said guide sleeve.

7. A valve system as defined in claim 5, wherein said rotation lock is located in a region of said magnetic field sensor.

8. A valve system as defined in claim 1; and further comprising at least one magnetizable material which is assigned to said magnetic field sensor to concentrate a flux of the magnetic field emitted by said permanent magnet.

9. A valve system as defined in claim 4, wherein said magnetic field sensor is located in a recess provided in a member selected from the group consisting of said guide sleeve, said valve housing and both and extending substantially transversely to a longitudinal axis of said valve element.

10. A valve system as defined in claim 1, wherein said magnetic field sensor includes at least one Hall effect sensor.

11. A valve system as defined in claim 1; and further comprising at least one shield which substantially shields said magnetic field sensor from external influences, said at least one shield being composed of a magnetically conductive material.

12. A valve system as defined in claim 11, wherein said at least one shield is composed of the magnetically conductive material selected from the group consisting of steel and steel-reinforced plastic.

13. A valve system as defined in claim 11, wherein said shield is configured as an element selected from the group consisting of at least one housing part of said valve housing, a hollow cylinder, a shield plate, a shield foil, a coating and a combination thereof.

14. A valve system as defined in claim 11; and further comprising a controlling magnet, said shield being connected with said controlling magnet in a magnetically conductive manner.

15. A valve system as defined in claim 1, wherein said permanent magnet is located in at least one receiving space such that it is spatially separated by a hydraulic fluid flow.

16. A valve system as defined in claim 1, wherein said magnetic field sensor is configured so that it serves as element selected from the group consisting of a position sensor for monitoring a valve position, a displacement pick-up in a proportional directional control valve, and both.

17. A valve system as defined in claim 16, wherein said position sensor for monitoring a valve position is configured as a valve selected from the group consisting of a pressure valve and a directional control valve.
